(19) United States
(12) Patent Application Publication
(10) Pub. No.: US 2011/0163723 A1
(43) Pub. Date: Jul. 7, 2011

(54) BATTERY PACK AND METHOD OF BATTERY PACK POWER MANAGEMENT

(75) Inventors: Eng Soon Dave Tan, Singapore (SG); Voon Ho Lee, Singapore (SG); Wah Swee Tan, Singapore (SG)

(73) Assignee: STL ENERGY TECHNOLOGY (S) PTE LTD, Singapore (SG)

(21) Appl. No.: 13/062,754

(22) PCT Filed: Sep. 23, 2008
(86) PCT No.: PCT/SG2008/000362

§ 371 Date: Mar. 8, 2011

(51) Int. Cl. H02J 7/00; H01M 2/00

(52) U.S. Cl. 320/134; 429/7

(57) ABSTRACT

A battery pack and a method of power management for a battery pack, the battery pack comprising a rechargeable power source; a protection circuit electrically isolated from the rechargeable power source in a shutdown mode of the battery pack; and a kickstart circuit for electrically connecting the protection circuit to the rechargeable power source for providing electrical protection when the battery pack is in any one of a plurality of operating states.

### FIELD OF INVENTION

The present invention relates broadly to a battery pack and to a method of power management for a battery pack.

### BACKGROUND

Presently, many electronic devices such as cordless power tools, light electric vehicles, computer notebooks and mobile phones are shipped with lithium-ion battery packs as they provide advantages such as high energy density, low self-discharge, no memory effect, longer run-time, light weight and small form factor when compared with conventional battery packs. However, lithium-ion battery packs require protection against unsafe operation due to e.g. over-charging, over-discharging or over-temperature conditions.

A lithium-ion battery pack is typically made up of one or more lithium-ion cells connected in series and parallel depending on its output energy requirements and/or protection control circuitry which monitors and ensures that the lithium-ion cells operate within their safe operating limits.

Typical battery packs comprise a Battery Management IC (BMIC) whose primary function is to monitor the battery pack's currents, voltages and temperatures. In the event when any of these monitored parameters exceeds their safe operating limits, the BMIC disables the power path between the rechargeable battery source and the attached external electronic device connected to the battery pack through the use of MOSFET switches. This may protect the battery pack and the external electronic device from damage due to circuit malfunctions arising from the exceeded parameters above.

In these typical battery packs, current consumption may be an issue. In general, such protection control circuitry draws current from the rechargeable battery source and may therefore reduce the operating time of the battery pack. To overcome the issue of power consumption, BMICs with lower power consumption may be used but these are limited in variety and may be expensive.

Therefore, there exists a need to provide a battery pack and to a method of power management of a battery pack, to address one or more of the problems mentioned above.

### SUMMARY

In accordance with a first aspect of the present invention, there is provided, a battery pack comprising a rechargeable power source; a protection circuit electrically isolated from the rechargeable power source in a shutdown mode of the battery pack; and a kickstart circuit for electrically connecting the protection circuit to the rechargeable power source for providing electrical protection when the battery pack is in any one of a plurality of operating states.

The protection circuit may comprise a plurality of monitor units for monitoring a plurality of monitored parameters; a power switching unit for electrically isolating the rechargeable power source when the monitored parameters exceed operation limits.

The battery pack may further comprise a controllable power supply for supplying power to the protection circuit.

The kickstart circuit may comprise means for receiving one or more input trigger signals; means for generating a wakeup signal in response to one of the input trigger signals to activate the controllable power supply; and means for generating a plurality of respective status signals in response to the input trigger signals.

The protection circuit may further comprise means for determining the operating state based on the output status signals; and means for generating a latch signal to retain activation of the controllable power supply.

The controllable power supply may comprise a power control circuit for receiving the wakeup and latch signals; and a buck regulator coupled to the power control circuit to provide a power supply to the protection circuit in response to the wakeup and latch signals.

One of the input trigger signals may be a remaining capacity trigger signal, the battery pack may further comprise a tactile switch for activating the remaining capacity input trigger signal by connecting the rechargeable power source to the kickstart circuit; a voltage scaling unit coupled to the protection circuit for measuring the rechargeable power source's voltage; and a battery capacity indicator for displaying the rechargeable power source's remaining capacity based on the measured voltage.

One of the input trigger signals may be a load present signal activated when the battery pack is electrically connected to an external load such that the load forms a closed circuit with the rechargeable power source and kickstart circuit.

One of the input trigger signals may be a charger present signal activated when the battery pack is electrically connected to an external charger such that the charger forms a closed circuit with the rechargeable power source and kickstart circuit.

The operating states may include one or more of battery pack charging, battery pack discharging and battery capacity indication.

The plurality of parameters may include one or more of battery pack voltage, battery pack current, and battery pack temperature.

In accordance with a second aspect of the present invention, there is provided a method of power management for a battery pack, comprising the steps of electrically isolating a protection circuit from a rechargeable power source in a shutdown mode of the battery pack; and electrically connecting the protection circuit to the rechargeable power source by a kick start circuit; said protection circuit providing electrical protection when the battery pack is in any one of a plurality of operating states.

Providing electrical protection when the battery pack is in any one of a plurality of operating states may comprise monitoring a plurality of monitored parameters with a plurality of monitor units; electrically isolating the rechargeable power source when the monitored parameters exceed operation limits with a power switching unit.

The method may further comprise supplying power to the protection circuit by a controllable power supply.

Electrically connecting the protection circuit to the rechargeable power source by a kick start circuit may comprise the steps of receiving one or more input trigger signals; generating a wakeup signal in response to one of the input trigger signals to activate the controllable power supply; and generating a plurality of respective status signals in response to the input trigger signals.

The method may further comprise determining the operating state based on the output status signals; and generating a latch signal to retain activation of the controllable power supply.

Supplying power to the protection circuit by a controllable power supply may further comprise receiving the wakeup and latch signals by a power control circuit; and coupling a buck regulator to the power control circuit to provide a power supply to the protection circuit in response to the wakeup and latch signals.

One of the input trigger signals may be a remaining capacity trigger signal, the method may further comprise activating the remaining capacity input trigger signal by connecting the rechargeable power source to the kickstart circuit by a tactile switch; measuring the rechargeable power source's voltage by a voltage scaling unit coupled to the protection circuit; and displaying the rechargeable power source's remaining capacity based on the measured voltage with a battery capacity indicator.

One of the input trigger signals may be a load present signal activated when the battery pack is electrically connected to an external load such that the load forms a closed circuit with the rechargeable'power source and kickstart circuit.

One of the input trigger signals may be a charger present signal activated when the battery pack is electrically connected to an external charger such that the charger forms a closed circuit with the rechargeable power source and kickstart circuit.

The operating states may include one or more of battery pack charging, battery pack discharging and battery capacity indication.

The plurality of parameters include one or more of battery pack voltage, battery pack current, and battery pack temperature.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 is a schematic block diagram illustrating an example embodiment of a battery pack.

FIG. 2 is a schematic illustration illustrating a circuit layout of functional blocks used to perform the remaining capacity status indication function in an example embodiment of a battery pack.

FIG. 3 is a schematic illustration illustrating a circuit layout of functional blocks used to perform the discharge control function in an example embodiment of a battery pack.

FIG. 4 is a schematic illustration illustrating a circuit layout of functional blocks used to perform the charge control function in an example embodiment of a battery pack.

FIG. 5 is a flowchart illustrating the power management method in the example embodiment.

FIG. 6 is a flowchart 600 illustrating a method of power management for an example embodiment of a battery pack.

### DETAILED DESCRIPTION

The example embodiments described hereafter may be able to overcome the shortcomings that have been described previously. The example embodiments provide a battery pack and an efficient power management method of powering on/off the battery pack depending on whether it is in use or not.

In typical battery packs, the typical battery pack's protection control circuitry draws current from the rechargeable battery source regardless of its status. In other words, the protection control circuitry draws current from the rechargeable battery source regardless of whether the battery pack is in use (in active mode) or not in use (in low power mode). Even in the low power mode, the current consumption can range from a few hundred μA to a few mA depending on the BMIC used. The low power mode's current consumption drains the rechargeable battery source and reduces the operating time of the battery pack. Embodiments of the present invention seek to provide a battery pack whose protection control circuitry is disconnected from the rechargeable battery source when the battery pack is not in use and therefore may provide longer operating time.

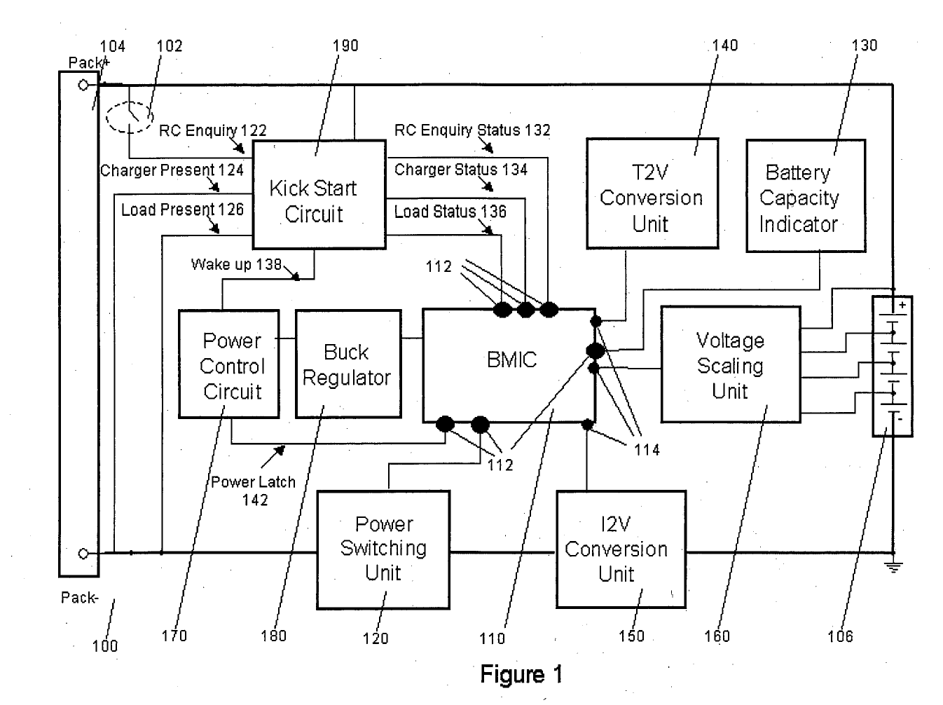

FIG. 1 shows an example embodiment of the battery pack 100. The battery pack 100 comprises a Battery Management Integrated Circuit (BMIC) 110, a Power Switching Unit 120, a Battery Capacity Indicator 130, a Temperature-to-Voltage (T2V) Conversion Unit 140, a Current-to-Voltage (I2V) Conversion Unit 150, a Voltage Scaling Unit 160, a Power Control Circuit 170, a Buck Regulator 180, a Kick Start Circuit 190, a Tactile Switch 102, a connector 104 for connecting to an external electronic device and a Rechargeable Battery Source 106. It will be appreciated by a person skilled in the art that the individual cells within the Rechargeable Battery Source 106 can be arranged in various parallel and series cell configurations.

In the example embodiment, the BMIC 110 is a general micro-controller (for example, the PIC16F690) with standard built-in arithmetic logic unit (ALU), memory, I/O ports 112 and ADC ports 114. The I/O ports 112 can be configured as output and input ports to control and monitor other functional blocks. One function of the BMIC 110 is to measure and monitor the battery pack's currents, voltages and temperatures via the I2V Conversion Unit 150, the Voltage Scaling Unit 160 and the T2V Conversion Unit 140 respectively using ADC ports 114 of the BMIC 110. In the event when any of the monitored parameters exceed their pre-determined safe operating limits, the BMIC 110 will open the power path between the Rechargeable Battery Source 106 and the external electronic device connected at connector 104 via the Power Switching Unit 120 to protect both the battery pack 100 and the external electronic device connected at the connector 104.

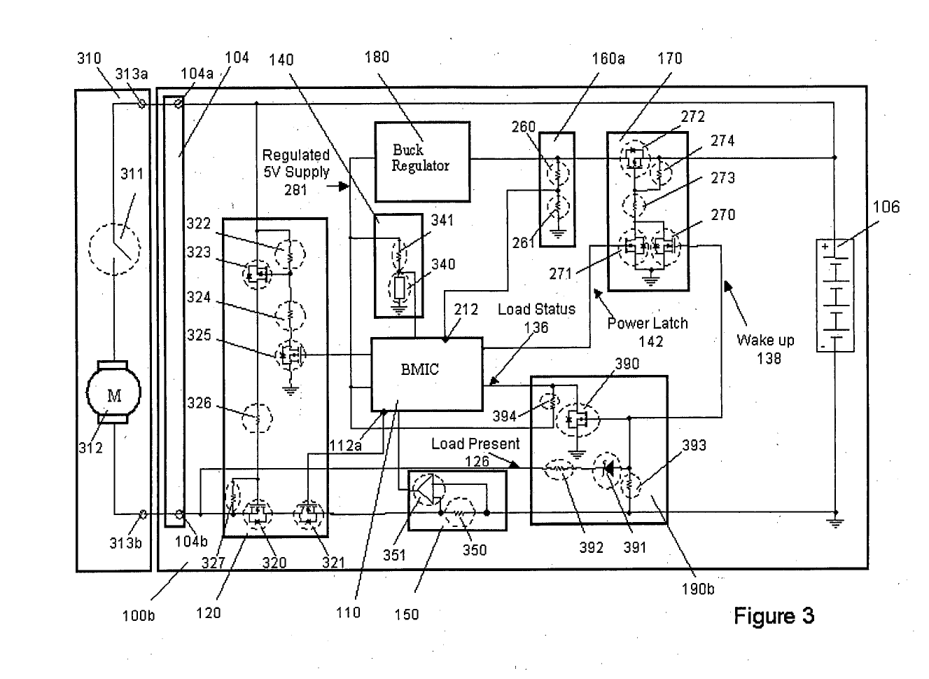

As illustrated in FIG. 3, the Power Switching Unit 120 in the example embodiment is made up of two N-Channel MOSFETs 320 and 321 and their driving circuitry 322 to 327 placed in the ground path between the Rechargeable Battery Source 106 and the external electronic device 310 connected at connector 104. It is used to control the current flow between the Rechargeable Battery Source 106 and the external electronic device 310. The T2V Conversion Unit 140 in the example embodiment is a resistive voltage divider comprising a thermistor 340 and a resistor 341, which performs temperature to voltage conversion. The T2V Conversion Unit 140 is used to monitor the temperatures of critical components such as the cells and MOSFETs for the battery pack's temperature protection. The thermistor 340 provides a variable resistance that is dependent on its body temperature. A voltage produced by the thermistor 340, resistor 341 and a regulated voltage reference 281 is used by the BMIC 110 to determine the temperature sensed by the thermistor 340. The I2V Conversion Unit 150 comprises an amplifier 351 and a current sensing resistor 350 in the ground path which performs current to voltage conversion. The polarity of the voltage produced across the current sensing resistor 350 is dependent on the direction of the current flow; the polarity is positive during discharging and is negative during charging. The amplifier 351 amplifies the voltage produced across the current sensing resistor 350 with a fixed gain and output a positive voltage regardless of the polarity of its input voltage. The output voltage of amplifier 351 is used by the BMIC 110 to determine the magnitude of the current flow. It will be appreciated by a person skilled in the art that the current sensing resistor 350 can be eliminated to reduce power loss and its function can be replaced by the drain-to-source resistance of the MOSFET 321 while it is turned on.

Returning to the example embodiment illustrated in FIG. 1, the Battery Capacity Indicator 130 is a LED or LCD display for indicating the remaining capacity of the Rechargeable Battery Source 106 using a voltage-based or coulomb counting fuel gauge implemented in the BMIC 110. The Voltage Scaling Unit 160 is a resistive voltage divider used to scale down each cell voltage level of the Rechargeable Battery Source 106 to an appropriate voltage level for the BMIC 110 to measure and monitor the individual cell voltages. The Buck Regulator 180 (for example, the single output LDO TPS71550 from Texas Instruments) is a step-down DC-DC regulator which gets its input supply from the Rechargeable Battery Source 106 and provides a regulated voltage supply of e.g. 5V for the BMIC 110. The Power Control Circuit 170 acts as an electrical switch to control the Rechargeable Battery Source 106 supply to the Buck Regulator 180 depending on the input signals from the BMIC 110 and the Kick Start Circuit 190. The Kick Start Circuit 190 monitors three kick start signals to determine if the Battery Pack 100 should be “kick-started” and powered up. These kick start signals are namely the RC Enquiry signal 122, Charger Present signal 124 and Load Present signal 126, which respectively corresponds to the activation of the three main functions. The RC Enquiry signal 122 is activated when a user wishes for the remaining battery capacity to be displayed by the Battery Capacity Indicator 130 and hence “remaining battery indication” function is desired from the BMIC 110. The Charger Present signal 124 is activated when a battery charger is electrically connected to the battery pack 100 at the connector 104 and hence a charge control function is desired from the BMIC 110. The Load Present signal 126 is activated when a load is electrically connected to the battery pack 100 at the connector 104 and a discharge control function is desired from the BMIC 110. The Kick Start Circuit 190 monitors the states of the three kick start signals 122, 124, 126. Depending on the states of the kick start signals 122, 124, 126, the Kick Start Circuit 190 generates the Wake up signal 138, which can power up the battery pack 100, and three status signals namely a RC Enquiry Status signal 132, a Charger Status signal 134 and a Load Status signal 136. Based on these three status signals 132, 134, 136, the BMIC 110 controls the battery pack to provide the required functions. For example, when all the three status signals 132, 134, 136 are in the “HIGH” (inactive) state, the BMIC 110 will drive a Power Latch signal 142 “LOW” to cut off the Rechargeable Battery Source 106 supply to the rest of the battery pack's electronic circuitry via the Power Control Circuit 170. This effectively shuts down the battery pack to conserve power.

In the example embodiment, the battery pack 100 is normally in shutdown mode so that it will not consume any power from the Rechargeable Battery Source 106. The battery pack 100 will only wake up from shutdown and consume power when it is required to perform the functions of

1. Remaining capacity status indication

2. Discharge control, or

3. Charge control.

The battery pack 100 will automatically shutdown again when these functions are no longer active. In the following, the internal operations of the battery pack and its power management method for the three functions, namely remaining capacity status indication, discharge control and charge control, are described.

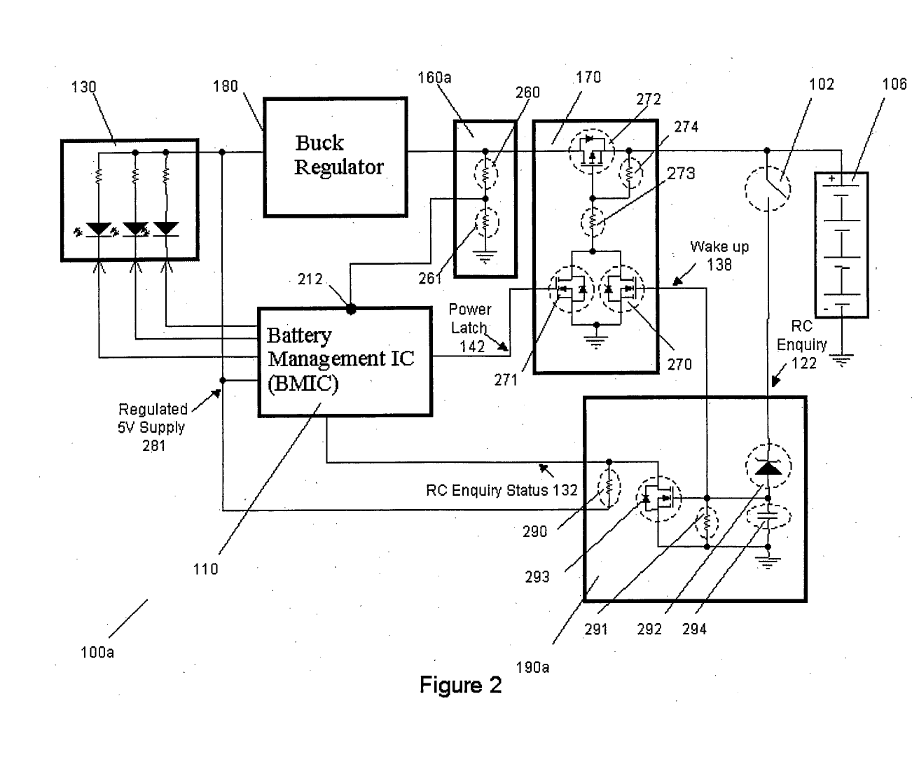

FIG. 2 is a schematic illustration illustrating a circuit layout of functional blocks used to perform the remaining capacity status indication function in an example embodiment of the battery pack 100a. The functional blocks shown in detail comprise the e.g. Kick Start Circuit 190a, the Power Control Circuit 170, the Battery Capacity Indicator 130 and the Voltage Scaling Unit 160a. Functional blocks, such as the T2V conversion unit 140 (FIG. 1) and I2V conversion unit 150 (FIG. 1), not utilised in the remaining capacity status indication function are not shown in FIG. 2 for clarity and ease of understanding. It will also be appreciated that the Kick Start Circuit 190a illustrated in FIG. 2, is a portion of the complete Kick Start Circuit 190 (FIG. 1), illustrating only the components required to kick start the battery pack 100a when the battery pack is performing the remaining capacity status function.

The Kick Start Circuit 190a detects and senses the activation of a Tactile Switch 102 to wake-up the battery pack. The Kick Start Circuit 190a comprises a resistor 290, another resistor 291, a Zener diode 292, a MOSFET 293 and a capacitor 294. The breakdown voltage of the Zener diode 292 is selected based on the undervoltage protection threshold of the Rechargeable Battery Source 106 to minimize over-draining of the cells. The resistor 291 and the capacitor 294 form a timer circuit to extend the turn-on duration of MOSFET 293 and MOSFET 270 beyond the duration which the Tactile Switch 102 is activated. Resistor 290 is a pull-up resistor for the RC Enquiry Status signal 132. The Battery Management IC (BMIC) 110 senses the RC Enquiry Status signal 132 to determine if the source of the kickstart is from the Tactile Switch 102 and perform the remaining capacity indication function accordingly. In response to an input RC Enquiry signal 122 activated by the Tactile Switch 102, the Kick Start Circuit 190a generates a Wake up Signal 138 and a RC Enquiry Status signal 132.

The Power Control Circuit 170 functions as a power, switch for powering on/off the battery pack 100a (by connecting/disconnecting the Rechargeable Battery Source 106 from the Buck Regulator 180). It comprises a P-channel MOSFET 272, two N-channel MOSFETs 270, 271 and two resistors 273, 274. MOSFET 272 functions as an electrical switch between the Rechargeable Battery Source 106 and the rest of the electronic circuitry. Resistor 273 and resistor 274 are used to set the gate biasing voltage of MOSFET 272. MOSFET 272 is controlled either by the BMIC 110 or the Kick Start Circuit 190a via MOSFET 271 and MOSFET 270 respectively.

The Voltage Scaling Unit 160a is a resistive voltage divider comprising of a resistor 260 and a resistor 261. The battery voltage of the Rechargeable Battery Source 106 can be scaled down by this resistive voltage divider and monitored by an ADC port 212 of the BMIC 110. It will be appreciated by a person skilled in the art that the Voltage Scaling Unit 160a may be extended to monitor individual cell voltages of the Rechargeable Battery Source 106 with various connections as shown in FIG. 1 (Voltage Scaling Unit 160).

The Buck Regulator 180 is a step-down DC-DC regulator which gets its input supply from the Rechargeable Battery Source 106 and provides a regulated voltage supply 281 of e.g. 5V for the BMIC 110.

In the example embodiment, the battery pack 100a is in shutdown mode until it is activated to wake up such as when a user presses the Tactile Switch 102 momentarily to check the remaining capacity of the Rechargeable Battery Source 106. If the voltage of the Rechargeable Battery Source 106 is above its undervoltage protection threshold setting (hence breaking down the Zener diode 292), a kick start current will flow from the positive terminal of the Rechargeable Battery Source 106 through the closed Tactile Switch 102, Zener diode 292 and returns to the negative terminal of the Rechargeable Battery Source 106 via resistor 291 and capacitor 294. If the voltage across resistor 291 is above e.g. 2V, the potential can be sufficient to turn on MOSFET 270 and MOSFET 293. MOSFET 270 subsequently then turns on MOSFET 272 and connects the Buck Regulator 180 to the Rechargeable Battery Source 106. The Buck Regulator 180 in turn provides a regulated voltage supply 281 of e.g. 5V to the BMIC 110 to power it up from its shutdown mode. After the BMIC 110 has been initialized and powered up, the BMIC 110 drives the Power Latch signal 142 “HIGH” to turn on MOSFET 271 to maintain MOSFET 272 in the “ON” state. The BMIC 110 senses that the RC Enquiry Status signal 132 is being held “LOW” (“ON”) by MOSFET 293 and proceeds to perform the remaining capacity function. The BMIC 110 measures the voltage of the Rechargeable Battery Source 106 via the Voltage Scaling Unit 160a to estimate its remaining capacity. It will be appreciated by a person skilled in the art that this can be readily achieved by using the measured current and time duration to implement a coulomb counting fuel gauge. The BMIC 110 then sends the determined remaining capacity information to the Battery Capacity Indicator 130 for display. The BMIC 110 continues to monitor the RC Enquiry Status signal 132. When the time delay set by Resistor 291 and Capacitor 294 after the Tactile Switch 102 is released has expired, MOSFET 293 and MOSFET 270 will be turned off and the RC Enquiry Status signal 132 will be pulled “HIGH” (“OFF”) via resistor 290. Once the BMIC 110 senses that the RC Enquiry Status signal 132 is “HIGH”, it drives the Power Latch signal 142 “LOW” to turn off MOSFET 271 which subsequently turns off MOSFET 272. With MOSFET 272 off, the power from the Rechargeable Battery Source 106 to the Buck Regulator 180 is cut off and shuts down the power supply to the electronic circuitry of the battery pack, hence conserving poker.

FIG. 3 is a schematic illustration illustrating a circuit layout of functional blocks used to perform the discharge control function in an example embodiment of a battery pack. The functional blocks shown in detail comprise the Kick Start Circuit 190b, the Power Control Circuit 170, the Voltage Scaling Unit 160a, the T2V Conversion Unit 140, the I2V Conversion Unit 150 and the Power Switching Unit 120. Functional blocks, such as the Battery Capacity Indicator 130 (shown in FIGS. 1 and 2), not utilised in the discharge control function are not shown in FIG. 3 for clarity and ease of understanding. It will also be appreciated that the Kick Start Circuit 190b illustrated in FIG. 3, is a portion of the complete Kick Start Circuit 190 (FIG. 1), illustrating only the components required to kick start the battery pack 100b when the battery pack is performing the discharge control function. The components previously shown in Kick Start Circuit 190a (FIG. 2) are not shown here.

The Battery Pack 100b comprises a Power Control Circuit 170, a Voltage Scaling Unit 160a, a Buck Regulator 180, a T2V Conversion Unit 140, a Power Switching Unit 120, a Battery Management IC (BMIC) 110, a I2V Conversion Unit 150, a Rechargeable Battery Source 106, a Kick Start Circuit 190b, a positive terminal 104a and a negative terminal 104b of connector 104 for connecting to an external electronic device such as a power tool 310.

The Power Tool 310 comprises a DC Power Switch 311, a DC Motor 312, a positive terminal 313a and a negative terminal 313b.

The Kick Start Circuit 190b detects and senses the activation of the DC Power Switch 311 of the Power Tool 310 to wake-up the Battery Pack 100b. The Kick Start Circuit 190b comprises an N-channel MOSFET 390, a Zener diode 391 and three resistors 392, 393, 394. The Zener diode 391 is used to set the undervoltage threshold of the Rechargeable Battery Source 106 to minimize over-draining the cells. Resistor 392 and resistor 393 can be selected to be in the range of e.g. Mega ohm to limit the kick start current to a low value, so as not to cause any disturbance to the Power Tool 310 load. MOSFET 390 and pull-up resistor 394 determines the state of the Load Status signal 136 and the BMIC 110 senses the Load Status signal 136 to determine if the source of the kick start is from the DC Power Switch 311 and hence perform the discharge control function accordingly. In response to an input Load Present signal 126 activated by the DC Power Switch 311, the Kick Start Circuit 190b generates a Wake up Signal 138 and a Load Status signal 136.

The Power Control Circuit 170 functions as a power switch for powering on/off the Battery Pack 100b and has been previously described under FIG. 2. It comprises a P-channel MOSFET 272, two N-channel MOSFETs 270, 271, and two resistors 273, 274. MOSFET 272 functions as an electrical switch between the Rechargeable Battery Source 106 and the rest of the electronic circuitry. Resistor 273 and resistor 274 are used to set the gate biasing voltage for MOSFET 272. MOSFET 272 is controlled by BMIC 110 and Kick Start Circuit 190b via MOSFET 271 and MOSFET 270 respectively.

The Voltage Scaling Unit 160a is a resistive voltage divider comprising of a resistor 260 and a resistor 261, and has been previously described under FIG. 2. The battery voltage of the Rechargeable Battery Source 106 can be scaled down by this resistive voltage divider and monitored by an ADC port 212 of the BMIC 110. It will be appreciated by a person skilled in the art that the Voltage Scaling Unit 160a may be extended to monitor individual cell voltages of the Rechargeable Battery Source 106 with connections as shown in FIG. 1 (Voltage Scaling Unit 160).

The Buck Regulator 180 is a step-down DC-DC regulator which gets its input supply from the Rechargeable Battery Source 106 and provides a regulated voltage supply 281 of e.g. 5V for the BMIC 110.

The T2V Conversion Unit 140 is a resistive voltage divider comprising a resistor 341 and a thermistor 340, which performs temperature to voltage conversion. The T2V Conversion Unit 140 allows the BMIC 110 to monitor the temperatures of critical components such as cells and MOSFETs for Battery Pack 100b's temperature protection. Thermistor 340 has a variable resistance that is dependent on its body temperature. A voltage produced by thermistor 340, resistor 341 and the regulated 5V supply 281 is used by the BMIC 110 to determine the temperature sensed by thermistor 340.

In the example embodiment, The I2V Conversion Unit 150 comprises an amplifier 351 and a current sensing resistor 350 in the ground path which performs current to voltage conversion. The polarity of the voltage produced across the current sensing resistor 350 is dependent on the direction of the current flow; the polarity is positive during discharging and is negative during charging. The amplifier 351 amplifies the voltage produced across the current sensing resistor 350 with a fixed gain and output a positive voltage regardless of the polarity of its input voltage. The output voltage of amplifier 351 is used by the BMIC 110 to determine the magnitude of the current flow. It will be appreciated by a person skilled in the art that the current sensing resistor 350 can be eliminated to reduce power loss and its function can be replaced by the drain-to-source resistance of the MOSFET 321 while it is turned on.

The Power Switching Unit 120 comprises two high current N-channel MOSFETs 320 and 321, a P-channel MOSFET 323, an N-channel MOSFET 325 and four resistors 322, 324, 326, 327. The high current MOSFET 321 is used to control the discharge current path between the Battery Pack 100b and the Power Tool 310 load. The gate of MOSFET 321 is driven by I/O port 112a of the BMIC 110 with the gate driven “HIGH” to allow current flow from the Battery Pack 100b to Power Tool 310 load during normal condition; otherwise it is driven “LOW” to turn off MOSFET 321. The high current MOSFET 320 is used to control the charge current path between the Battery Pack 100b and an external battery charger when an external battery charger is electrically connected to the battery pack 100b at the connector 104. MOSFET 320 is indirectly controlled by the BMIC 110 via a driving circuit formed by MOSFET 323, MOSFET 325, and resistors 322, 324, 326, 327. When the gate drive of MOSFET 325 is driven “HIGH” by the BMIC 110, a positive drive voltage is applied to the gate of MOSFET 320 via MOSFET 323 to enable the charging path. Conversely, MOSFET 320 is turned off to disable the charging path. Resistors 322, 324 are used to set the gate biasing voltage for MOSFET 323. Similarly, resistor 326 and resistor 327 are used to set the gate biasing voltage for MOSFET 320.

In the example embodiment, the Battery Pack 100b is in shutdown mode until it is activated to wake up such as when a user presses the DC Power Switch 311 on the Power Tool 310. If the voltage of the Rechargeable Battery Source 106 is above its undervoltage protection threshold setting, a kick start current will flow from the positive terminal of the Rechargeable Battery Source 106 to the Power Tool 310 via terminal 104a, terminal 313a, DC Power Switch 311, Motor 312, terminal 313b, terminal 104b, resistor 392, Zener diode 391, resistor 393 before returning to the negative terminal of the Rechargeable Battery Source 106. The small kick start current appears as an input Load Present signal 126 at the Kick Start Circuit 190b. This small kick start current is too low to start the Motor 312 but is sufficient to operate the Kick Start Circuit 190b. If the voltage drop across resistor 393 is above e.g. 2V, it will turn on MOSFET 270 and MOSFET 390. MOSFET 270 will then turn on MOSFET 272 and connect the Buck Regulator 180 to the Rechargeable Battery Source 106. The Buck Regulator 180 will provide a regulated voltage supply 281 of e.g. 5V to the BMIC 110 to power it up from its shutdown mode. After the BMIC 110 has been initialized and is running, the BMIC 110 drives the Power Latch signal 142 “HIGH” to turn on MOSFET 271 to maintain MOSFET 272 in the “ON” state. The BMIC 110 senses that the Load Status signal 136 is being held “LOW” (“ON”) by MOSFET 390 and proceeds to perform the discharge control function. The BMIC 110 measures the voltage and temperature of the Rechargeable Battery Source 106 via the Voltage Scaling Unit 160a and T2V Conversion Unit 140 respectively. If both the voltage and temperature are within their safe operating limits (i.e. Battery Pack 100b is safe to operate), BMIC 110 will turn on MOSFET 320 and MOSFET 321 to connect the ground path between the Power Tool 310 and the Rechargeable Battery Source 106. Power is now supplied from the Rechargeable Battery Source 106 to operate the Power Tool 310. The Load Present signal 126 is now grounded and the Kick Start Circuit 190b will be disabled. The BMIC 110 will now monitor the load current via the I2V Conversion Unit 150 to determine the Power Tool 310 load status. MOSFET 320 and MOSFET 321 will remain “ON” as long as there is a discharge current (i.e. DC Power Switch 311 remains pressed) and the monitored Rechargeable Battery Source 106's cell voltages, temperature and discharge current are operating within their safe limits. When the BMIC 110 senses that there is no discharge current continuously for a pre-determined time duration, it will momentarily turn off MOSFET 320 and MOSFET 321 for a pre-determined time duration to enable the Kick Start Circuit 190b and check the Load Status signal 136. If the signal 136 is “HIGH” (i.e. the DC Power Switch 311 has been released), the BMIC 110 will drive the Power Latch signal 142 “LOW” to turn off MOSFET 271 which then turns off MOSFET 272. This cuts off the power from the Rechargeable Battery Source 106 to the Buck Regulator 180 and shutdown the electronic circuitry of the Battery Pack 100b to conserve power. Otherwise, the BMIC 110 will turn on MOSFET 320 and 321 as the DC Power Switch 311 determined to still be activated (pressed) but the discharge current may be too low to be measured. For example, some Power Tools have a built-in torchlight (consumes very low current) which will turn on when its DC Power Switch 311 is first pressed slightly and the motor will only start when the DC Power Switch is pressed further. The BMIC 110 will continuously carry out the above operation to determine the DC Power Switch 311 status via the Load Status signal 136 until the DC Power Switch 311 is released.

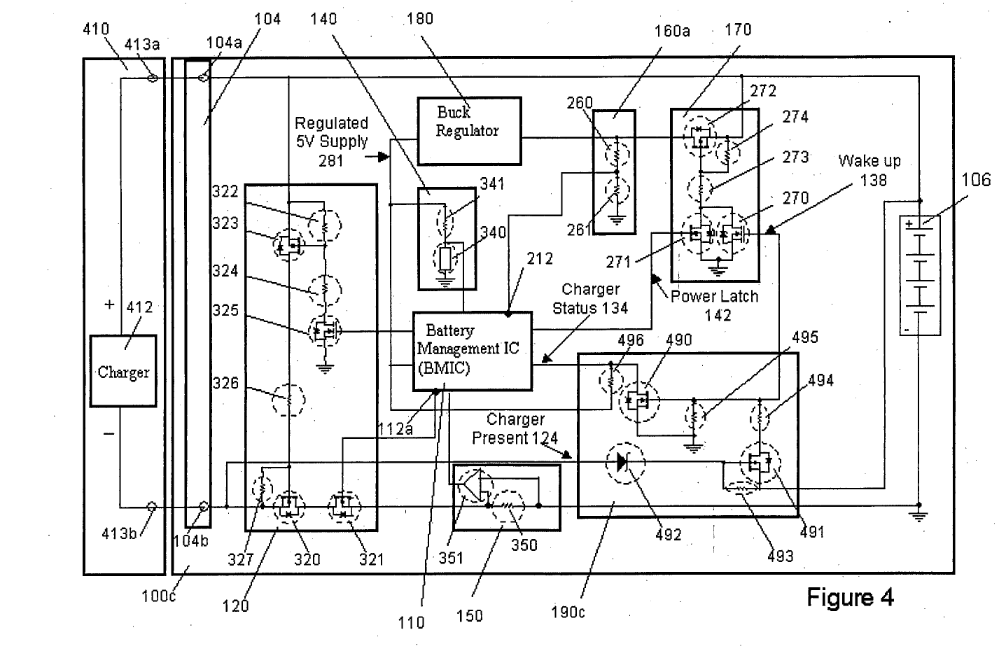

FIG. 4 is a schematic illustration illustrating a circuit layout of functional blocks used to perform the charge control function in an example embodiment of a battery pack. The functional blocks shown in detail comprise the Kick Start Circuit 190c, the Power Control Circuit 170, the Voltage Scaling Unit 160a, the T2V Conversion Unit 140, the I2V Conversion Unit 150 and the Power Switching Unit 120. Functional blocks, such as the Battery Capacity Indicator 130 (shown in FIGS. 1 and 2), not utilised in the charge control function are not shown in FIG. 4 for clarity and ease of understanding. It will also be appreciated that the Kick Start Circuit 190c illustrated in FIG. 4, is a portion of the complete Kick Start Circuit 190 (FIG. 1), illustrating only the components required to kick start the battery pack 100c when the battery pack 100c is performing the charge control function. The components previously shown in Kick Start Circuits 190a (FIG. 2), 190b (FIG. 3) are not shown here.

The Battery Pack 100c comprises a Power Control Circuit 170, a Voltage Scaling Unit 160a, a Buck Regulator 180, a T2V Conversion Unit 140, a Power Switching Unit 120, a Battery Management IC (BMIC) 110, a I2V Conversion Unit 150, a Rechargeable Battery Source 106, a Kick Start Circuit 190c, a positive terminal 104a and a negative terminal 104b of connector 104 for connecting to an external electronic device such as a battery charger 410 in this example embodiment. The Battery Charger 410 comprises a Charger PCB 412 which converts AC power to DC power with a DC output at positive terminal 413a and negative terminal 413b.

The Kick Start Circuit 190c detects and senses the presence of the Battery Charger 410 to wake-up the Battery Pack 100c. It comprises an N-channel MOSFET 490, a P-channel MOSFET 491, a Zener diode 492, and four resistors 493 to 496. MOSFET 491 is designed to turn “ON” when a charger voltage is applied at terminals 104a and 104b. This charger voltage must be at least e.g. 2V higher than the breakdown voltage of Zener diode 492. MOSFET 490 and resistor 496 determine the state of the Charger Status signal 134. The BMIC 110 senses the signal 134 to determine if the source of the kick start is from the Battery Charger 410 to perform the charge control function. In response to an input Charger Present signal 124 from the Battery Charger 410, the Kick Start Circuit 190c generates the Wake up Signal 138 and the Charger Status signal 134.

The Power Control Circuit 170 functions as a power switch for powering on/off the Battery Pack 100c and has been previously described under FIG. 2. It comprises a P-channel MOSFET 272, two N-channel MOSFETs 270, 271, and two resistors 273, 274. MOSFET 272 functions as an electrical switch between the Rechargeable Battery Source 106 and the rest of the electronic circuitry. Resistor 273 and resistor 274 are used to set the gate biasing voltage for MOSFET 272. MOSFET 272 is controlled by BMIC 110 and Kick Start Circuit 190c via MOSFET 271 and MOSFET 270 respectively.

The Voltage Scaling Unit 160a is a resistive voltage divider comprising of a resistor 260 and a resistor 261, and has been previously described under FIG. 2. The battery voltage of the Rechargeable Battery Source 106 can be scaled down by this resistive voltage divider and monitored by an ADC port 212 of the BMIC 110. It will be appreciated by a person skilled in the art that the Voltage Scaling Unit 160a may be extended to monitor individual cell voltages of the Rechargeable Battery Source 106 with connections as shown in FIG. 1 (Voltage Scaling Unit 160).

The Buck Regulator 180 is a step-down DC-DC regulator which gets its input supply from the Rechargeable Battery Source 106 and provides a regulated voltage supply 281 of e.g. 5V for the BMIC 110.

The T2V Conversion Unit 140 is a resistive voltage divider comprising a resistor 341 and a thermistor 340, which performs temperature to voltage conversion. It is used to monitor the temperatures of critical components such as cells and MOSFETs for Battery Pack 100c's temperature protection. Thermistor 340 has a variable resistance that is dependent on its body temperature. A voltage produced by thermistor 340, resistor 341 and the regulated 5V supply 281 is used by the BMIC 110 to determine the temperature sensed by thermistor 340.

In the example embodiment, The I2V Conversion Unit 150 comprises an amplifier 351 and a current sensing resistor 350 in the ground path which performs current to voltage conversion. The polarity of the voltage produced across the current sensing resistor 350 is dependent on the direction of the current flow; the polarity is positive during discharging and is negative during charging. The amplifier 351 amplifies the voltage produced across the current sensing resistor 350 with a fixed gain and output a positive voltage regardless of the polarity of its input voltage. The output voltage of amplifier 351 is used by the BMIC 110 to determine the magnitude of the current flow. It will be appreciated by a person skilled in the art that the current sensing resistor 350 can be eliminated to reduce power loss and its function can be replaced by the drain-to-source resistance of the MOSFET 321 while it is turned on.

The Power Switching Unit 120 has been described in detail earlier under FIG. 3. The unit 120 comprises two high current N-channel MOSFETs 320 and 321, a P-channel MOSFET 323, an N-channel MOSFET 325 and four resistors 322, 324, 326, 327. The high current MOSFET 321 is used to control the discharge current path between the Battery Pack 100c and a load 310 (as illustrated in FIG. 3). The gate of MOSFET 321 is driven by I/O port 112a of the BMIC 110 with the gate driven “HIGH” to allow current flow from the Battery Pack 100c to a load 310 (as illustrated in FIG. 3) during normal condition; otherwise it is driven “LOW” to turn off MOSFET 321. Returning to FIG. 4 where a charger 410 is connected instead, the high current MOSFET 320 is used to control the charge current path between the Battery Pack 100c and an external battery charger 410 when the external battery charger 410 is electrically connected to the battery pack 100c at the connector 104. MOSFET 320 is indirectly controlled by the BMIC 110 via a driving circuit formed by MOSFET 323, MOSFET 325, and resistors 322, 324, 326, 327. When the gate drive of MOSFET 325 is driven “HIGH” by the BMIC 110, a positive drive voltage is applied to the gate of MOSFET 320 via MOSFET 323 to enable the charging path. Conversely, MOSFET 320 is turned off to disable the charging path. Resistors 322, 324 are used to set the gate biasing voltage for MOSFET 323. Similarly, resistor 326 and resistor 327 are used to set the gate biasing voltage for MOSFET 320.

In the example embodiment, the Battery Pack 100c is in shutdown mode until it is activated to wake up such as when it is attached to Battery Charger 410. A small kick start current will flow from the positive terminal 413a of the Battery Charger 410 into the Battery Pack 100c via terminal 104a, resistor 493, Zener diode 492 and terminal 104b before returning to the Battery Charger 410 via its negative terminal 413b. The voltage produced across resistor 493 will turn on MOSFET 491 to form another current path around the Rechargeable Battery Source 106. Current will then flow from the positive terminal of the Rechargeable Battery Source 106 to resistor 494 and resistor 495 via MOSFET 491 before returning to its negative terminal (common ground). If the voltage drop across resistor 495 is above e.g. 2V, MOSFET 270 will turn on which then turns on MOSFET 272 and connect the Buck Regulator 180 to the Rechargeable Battery Source 106. The Buck Regulator 180 will provide a regulated voltage supply of e.g. 5V to the BMIC 110 to power it up from its shutdown mode. After the BMIC 110 has been initialized and running, it drives the Power Latch signal 142 “HIGH” to turn on MOSFET 271 to maintain MOSFET 272 in the “ON” state. The BMIC 110 senses that the Charger Status signal 134 is being held “LOW” (“ON”) by MOSFET 490 and proceeds to perform the charge control function. The BMIC 110 measures the voltage and temperature of the Rechargeable Battery Source 106 via the Voltage Scaling Unit 160a and T2V Conversion Unit 140 respectively. If both the voltage and temperature are within their safe operating limits (i.e. Battery Pack 100c is safe to charge), BMIC 110 will turn on MOSFET 320 and MOSFET 321 to connect the ground path between the Battery Charger 410 and the Rechargeable Battery Source 106 and the Battery Charger 410 will begin charging the Rechargeable Battery Source 106. The Kick Start Circuit 190c may be disabled due to MOSFET 491 turning off if the Battery Charger 410's output voltage is pulled down to the voltage level of the Rechargeable Battery Source 106 which may be lower than the breakdown voltage of Zener diode 492. Otherwise, MOSFET 491 may be left on due to the Rechargeable Battery Source 106 voltage. Therefore, BMIC 110 cannot rely on the Charger Status signal 134 to determine the status of the Battery Charger 410. Instead, the BMIC 110 will monitor the charge current via the I2V Conversion Unit 150 to determine the Battery Charger 410 status. MOSFET 320 and MOSFET 321 will remain “ON” as long as there is a charge current (through the I2V Conversion Unit) and the monitored Rechargeable Battery Source 106's cell voltages, temperature and charge current are within their safe operating limits. When the BMIC 110 senses that there is no charge current continuously for a pre-determined time duration, it will momentarily turn off MOSFET 320 and MOSFET 321 for a pre-determined time duration to enable the Kick Start Circuit 190c and check the Charger Status signal 134. If the signal is “HIGH” (i.e. Battery Charger 410 has been removed), the BMIC 110 will drive the Power Latch signal 142 “LOW” to turn off MOSFET 271 which will then turn off MOSFET 272. This cuts off the power from the Rechargeable Battery Source 106 to the Buck Regulator 180 and shuts down the electronic circuitry of the Battery Pack 100c to conserve power. Otherwise, it will turn on MOSFET 320 and 321 as the Battery Charger 410 is still connected but the charge current may be too low to be measured. The charging current may decrease, for example, during the constant voltage charging state and may be low e.g. 0.1 C towards the end of the charging cycle. The BMIC 110 will continuously carry out the above operation to determine the Battery Charger 410 status via Charger Status signal 134 until it is removed from the Battery Pack 100c.

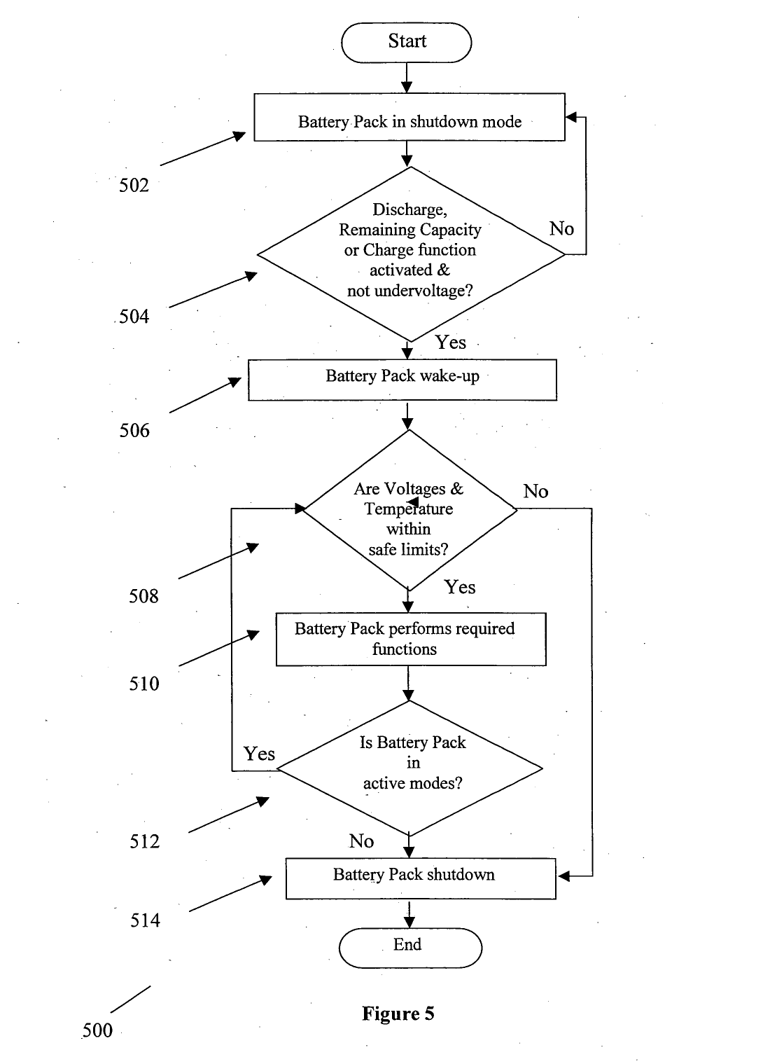

FIG. 5 is a flowchart 500 illustrating a power management method in an example embodiment. At step 502, a battery pack is normally in a shutdown mode. At step 504, an activation signal source such as remaining capacity status indication, discharge or charge control from a respective battery pack's tactile switch, external electronic device (load) or external battery charger is sensed. If an activation signal is sensed and the battery pack is not in undervoltage protection mode, the battery pack will wake up at step 506. At step 508, if the battery pack voltages and temperature are within safe operating limits, it will perform the required function at step 510. At step 512, if the battery pack is inactive, the battery pack will shutdown to conserve power in step 514.

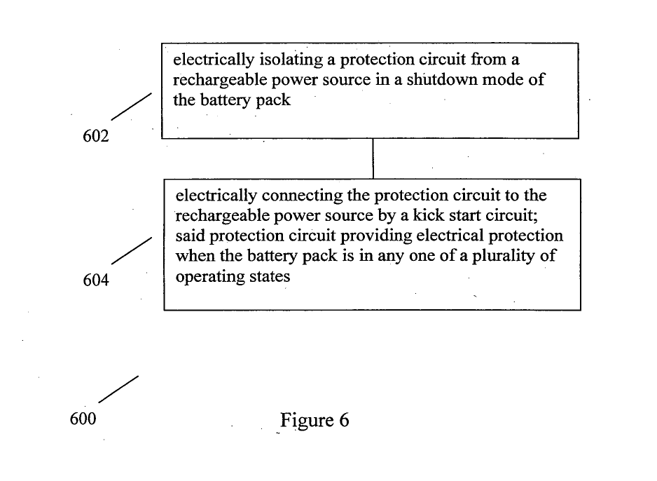

FIG. 6 is a flowchart 600 illustrating a method of power management for an example embodiment of a battery pack. At step 602, a protection circuit is isolated from a rechargeable power source in a shutdown mode of the battery pack. At step 604, protection circuit is electrically connected to the rechargeable power source by a kick start circuit; said protection circuit providing electrical protection when the battery pack is in any one of a plurality of operating states.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A battery pack comprising:
a rechargeable power source;
a protection circuit electrically isolated from the rechargeable power source in a shutdown mode of the battery pack; and
a kickstart circuit for electrically connecting the protection circuit to the rechargeable power source for providing electrical protection when the battery pack is in any one of a plurality of operating states;
said kickstart circuit comprising:
means for receiving a plurality of input trigger signals; and
means for determining the operating state of the battery pack based on
the input trigger signals; and
wherein different functional blocks of the kickstart circuit are activated for electrically connecting the protection circuit to the rechargeable power source depending on the determined operating state.

2. The battery pack is claimed in claim 1, wherein the protection circuit comprises:
a plurality of monitor units for monitoring a plurality of monitored parameters;
a power switching unit for electrically isolating the rechargeable power source when the monitored parameters exceed operation limits.

3. The battery pack as claimed in claim 1, further comprises a controllable power supply for supplying power to the protection circuit.

4. The battery pack as claimed in claim 3, wherein the kickstart circuit further comprises:
means for generating a wakeup signal in response to one of the input trigger signals to activate the controllable power supply; and
means for generating a plurality of respective status signals in response to the input trigger signals.

5. The battery pack as claimed in claim 4, wherein the protection circuit further comprises means for generating a latch signal to retain activation of the controllable power supply.

6. The battery pack as claimed in claim 5, wherein the controllable power supply comprises:
a power control circuit for receiving the wakeup and latch signals; and
a buck regulator coupled to the power control circuit to provide a power supply to the protection circuit in response to the wakeup or latch signals.

7. The battery pack as claimed in claim 4, wherein one of the input trigger signals is a remaining capacity trigger signal, the battery pack further comprising
a tactile switch for activating the remaining capacity input trigger signal by connecting the rechargeable power source to the kickstart circuit;
a voltage scaling unit coupled to the protection circuit for measuring the rechargeable power source's voltage; and
a battery capacity indicator for displaying the rechargeable power source's remaining capacity based on the measured voltage.

8. The battery pack as claimed in claim 4, wherein one of the input trigger signals is a load present signal activated when the battery pack is electrically connected to an external load such that the load forms a closed circuit with the rechargeable power source and kickstart circuit.

9. The battery pack as claimed in claim 4, wherein one of the input trigger signals is a charger present signal activated when the battery pack is electrically connected to an external charger such that the charger forms a closed circuit with the rechargeable power source and kickstart circuit.

10. The battery pack as claimed in claim 1, wherein the operating states include one or more of battery pack charging, battery pack discharging and battery capacity indication.

11. The battery pack as claimed in claim 2, wherein the plurality of parameters includes one or more of battery pack voltage, battery pack current, and battery pack temperature.

12. A method of power management for a battery pack, comprising the steps of:
electrically isolating a protection circuit from a rechargeable power source in a shutdown mode of the battery pack; and
electrically connecting the protection circuit to the rechargeable power source by a kick start circuit; said protection circuit providing electrical protection when the battery pack is in any one of a plurality of operating states; and
said kickstart circuit determining the operating state based on one or more received input trigger signals; and
wherein different functional blocks of the kickstart circuit are activated for electrically connecting the protection circuit to the rechargeable power source depending on the determined operating state.

13. The method as claimed in claim 12, wherein providing electrical protection when the battery pack is in any one of a plurality of operating states comprises:
monitoring a plurality of monitored parameters with a plurality of monitor units;
electrically isolating the rechargeable power source when the monitored parameters exceed operation limits with a power switching unit.

14. The method as claimed in claim 12, further comprising supplying power to the protection circuit by a controllable power supply.

15. The method as claimed in claim 14, wherein electrically connecting the protection circuit to the rechargeable power source by a kick start circuit comprises the steps of:
generating a wakeup signal in response to one of the input trigger signals to activate the controllable power supply; and
generating a plurality of respective status signals in response to the input trigger signals.

16. The method as claimed in claim 15, further comprising generating a latch signal to retain activation of the controllable power supply.

17. The method as claimed in claim 16, wherein supplying power to the protection circuit by a controllable power supply further comprises:
receiving the wakeup and latch signals by a power control circuit; and
coupling a buck regulator to the power control circuit to provide a power supply to the protection circuit in response to the wakeup and latch signals.

18. The method as claimed in claim 15, wherein one of the input trigger signals is a remaining capacity trigger signal, the method further comprising:
activating the remaining capacity input trigger signal by connecting the rechargeable power source to the kickstart circuit by a tactile switch;
measuring the rechargeable power source's voltage by a voltage scaling unit coupled to the protection circuit; and
displaying the rechargeable power source's remaining capacity based on the measured voltage with a battery capacity indicator.

19. The method as claimed in claim 15, wherein one of the input trigger signals is a load present signal activated when the battery pack is electrically connected to an external load such that the load forms a closed circuit with the rechargeable power source and kickstart circuit.

20. The method as claimed in claim 15, wherein one of the input trigger signals is a charger present signal activated when the battery pack is electrically connected to an external charger such that the charger forms a closed circuit with the rechargeable power source and kickstart circuit.

21. The method as claimed in claim 12, wherein the operating states include one or more of battery pack charging, battery pack discharging and battery capacity indication.

22. The method as claimed in claim 13, wherein the plurality of parameters includes one or more of battery pack voltage, battery pack current, and battery pack temperature.
